(19) United States
(12) Patent Application Publication
(10) Pub. No.: US 2024/0053706 A1
(43) Pub. Date: Feb. 15, 2024

(54) ELECTRONIC BOOK DISPLAY SYSTEM AND ELECTRONIC BOOK DISPLAY PROGRAM

(71) Applicant: Katsunori SUETSUGU, Tokyo (JP)

(72) Inventor: Katsunori SUETSUGU, Tokyo (JP)

(21) Appl. No.: 18/230,816

(22) Filed: Aug. 7, 2023

(30) Foreign Application Priority Data
Aug. 10, 2022 (JP) 2022-127657

(51) Int. Cl. G03H 1/22; H04N 13/302

(52) U.S. Cl. CPC G03H 1/2294; H04N 13/302

(57) ABSTRACT

An electronic book display system includes a hologram generation unit that generates a hologram to reproduce an electronic book as a stereoscopic image of a book, and a display control unit that causes an SLM to display the hologram generated by the hologram generation unit.

### CROSS REFERENCE TO RELATED APPLICATION

This application is based upon and claims the benefit of priority from Japanese Patent Application No. 2022-127657 filed Aug. 10, 2022, the entire contents of which are incorporated herein by reference.

### BACKGROUND OF THE INVENTION

### 1. Technical Field

The present invention relates to an electronic book display system and an electronic book display program for displaying an electronic book.

### 2. Description of the Related Art

As a conventional electronic book display system, a mobile terminal is known (see, for example, JP 2017-182167 A). The mobile terminal described in JP 2017-182167 A includes a main touch panel that is disposed on a front surface of the mobile terminal and displays a magazine image of an electronic book, a right side touch panel that is disposed along a right short side of the main touch panel and displays an image of a right edge of the electronic book, a left side touch panel that is disposed along a left short side of the main touch panel and displays an image of a left edge of the electronic book, a right pressure sensitive sensor that extends in parallel with the right short side in the vicinity of the right short side on a back surface of the mobile terminal, a left pressure sensitive sensor that extends in parallel with the left short side in the vicinity of the left short side on the back surface of the mobile terminal, and an acceleration sensor that measures acceleration and detects a change in posture such as inclination and movement of the mobile terminal. Then, the portable terminal described in JP 2017-182167 A can perform page turning of the electronic book with the same operation feeling as a book of a paper medium based on an input operation by the right thumb of the user detected by the right side touch panel, an input operation by the left thumb of the user detected by the left side touch panel, pressing from the back surface of the portable terminal by the right index finger, middle finger, ring finger, and little finger of the user detected by the right pressure sensitive sensor, pressing from the back surface of the portable terminal by the left index finger, middle finger, ring finger, and little finger of the user detected by the left pressure sensitive sensor, and a change in posture such as inclination and movement of the portable terminal detected by the acceleration sensor.

### SUMMARY OF THE INVENTION

However, in conventional electronic book display systems, since the image of the book is planar, the appearance of the book is significantly different from that of the book on the paper medium, and this causes a problem that it cannot be comfortably used by a person familiar with the book on the paper medium.

Therefore, an object of the present invention is to provide an electronic book display system and an electronic book display program capable of improving comfort of using an electronic book.

An electronic book display system according to the present invention includes a hologram generation unit that generates a hologram to reproduce an electronic book as a stereoscopic image of a book, and a display control unit that causes a spatial light modulator (SLM) to display the hologram generated by the hologram generation unit.

With this configuration, the electronic book display system according to the present invention reproduces the electronic book as a stereoscopic image of the book, so that the difference in the appearance of the book from the book of the paper medium can be reduced, and as a result, the comfort of using the electronic book can be improved.

In the electronic book display system according to the present invention, the hologram is for reproducing a real image of the book, and the electronic book display system may include a position detection unit that detects a spatial position of an object in a region for a real image of the book to detect an operation by the object with respect to the real image of the book that is reproduced by the hologram, and in a case where the position detection unit detects an operation by the object with respect to the real image of the book, the hologram generation unit generates the hologram in which the real image of the book is changed according to the operation detected by the position detection unit.

With this configuration, the electronic book display system according to the present invention generates the hologram in which the real image of the book is changed according to the operation detected by the position detection unit when the operation on the real image of the book by the object is detected by the position detection unit, and thus can give the user a feeling of directly operating the real image of the book. Therefore, the electronic book display system according to the present invention can reduce a difference in the book operability from the book on the paper medium, and as a result, the comfort of using the electronic book can be improved. In the electronic book display system according to the present invention, the hologram generation unit can generate the hologram in which, while a display content of a page of the book is visible from a first viewpoint with respect to the SLM, at least a part of an area of an exterior of the book that is not visible from the first viewpoint can be visible from a second viewpoint with respect to the SLM.

With this configuration, in a case where the display content of the page of the book is visible from the first viewpoint with respect to the SLM, the electronic book display system according to the present invention can display, on the SLM, the hologram in which at least a part of the exterior of the book that is not visible from the first viewpoint is visible from the second viewpoint with respect to the SLM. Therefore, when the user is viewing the display content of the page of the book, the exterior of the book is visible from a person other than the user.

In the electronic book display system according to the present invention, the hologram generation unit may be capable of generating a first hologram that is the hologram in a case where a book cover covering at least a part of an exterior of the book is not attached to the book, and may be capable of generating a second hologram that is the hologram different from the first hologram in a case where the book cover is attached to the book.

With this configuration, the electronic book display system according to the present invention can generate a hologram in which the book cover is not attached in the book, and can generate a hologram in which the book cover is attached in the book, so that the book cover can be attached in the book reproduced by the hologram.

In the electronic book display system according to the present invention, in a case where display content of a page of the book is visible from a first viewpoint with respect to the SLM, in the first hologram, at least a part of an area of an exterior of the book that is not visible from the first viewpoint may be visible from a second viewpoint with respect to the SLM, and in the second hologram, the book cover may cover at least a part of the area of the exterior of the book that is not visible from the first viewpoint and is visible from the second viewpoint in the first hologram.

With this configuration, in the electronic book display system according to the present invention, in a case where the book cover is not attached to the book and the display content of the page of the book is viewed from the first viewpoint with respect to the SLM, at least a part of the exterior of the book that is not visible from the first viewpoint is visible from the second viewpoint with respect to the SLM, and in a case where the book cover is attached to the book, the book cover covers at least a part of the exterior of the book that is not visible from the first viewpoint and is visible from the second viewpoint when the book cover is not attached to the book. Thus, when the user is viewing the display content of the page of the book, at least a part of the exterior of the book can be hidden by the book cover from a person other than the user.

In the electronic book display system according to the present invention, the hologram generation unit generates an appearance of the book to be an appearance corresponding to how much the electronic book has been read.

With this configuration, the electronic book display system according to the present invention makes the appearance of the book reproduced by the hologram according to the reading amount of the electronic book, so that the user can easily recognize the reading amount of the electronic book.

In the electronic book display system according to the present invention, in a case where an operation of breaking a page of the book is executed, the hologram generation unit can generate the hologram in which the page is broken.

With this configuration, the electronic book display system according to the present invention generates the hologram in which the page of the book is broken when the operation of breaking the page of the book is executed, and thus, the difference from the book of the paper medium in terms of operability and appearance of the book can be reduced, and as a result, the comfort of using the electronic book can be improved.

In the electronic book display system according to the present invention, in a case where an operation of folding a page of the book is executed, the hologram generation unit generates the hologram in which the page is folded.

With this configuration, the electronic book display system according to the present invention generates the hologram in which the page of the book is folded when the operation of folding the page of the book is executed, and thus, the difference from the book of the paper medium in terms of operability and appearance of the book can be reduced, and as a result, the comfort of using the electronic book can be improved.

In the electronic book display system according to the present invention, regarding the electronic book, a property amount, as an amount of property of a component of the book, is set, and the hologram generation unit generates the hologram such that a page of the book is turned at a speed corresponding to the property amount.

With this configuration, the electronic book display system according to the present invention generates the hologram such that the pages of the book are turned at a speed corresponding to the property amount of the components of the book, so that the speed at which the pages of the book are turned can be set to a speed corresponding to the property amount of the parts of the book.

In the electronic book display system according to the present invention, when changing the appearance of the book, the hologram generation unit may set the property amount according to the changed appearance in the electronic book.

With this configuration, in a case where the appearance of the book is changed, the electronic book display system according to the present invention sets the property amount according to the changed appearance to the electronic book, so that the page turning speed of the book can be set to a speed according to the appearance of the book.

An electronic book display program of the present invention causes a computer to implement a hologram generation unit that generates a hologram to reproduce an electronic book as a stereoscopic image of a book, and a display control unit that causes a spatial light modulator (SLM) to display the hologram generated by the hologram generation unit.

With this configuration, the computer that executes the electronic book display program according to the present invention reproduces the electronic book as a stereoscopic image of the book, so that the difference in the appearance of the book from the book of the paper medium can be reduced, and as a result, the comfort of using the electronic book can be improved.

The electronic book display system and the electronic book display program according to the present invention can improve the comfort of using the electronic book.

### BRIEF DESCRIPTION OF THE DRAWINGS

FIG. 1 is a block diagram of an electronic book display system according to an embodiment of the present invention;

FIG. 2A is a front view of an SLM illustrated in FIG. 1; FIG. 2B is a rear view of the SLM illustrated in FIG. 1;

FIG. 3A is a top view of the SLM illustrated in FIG. 1; FIG. 3B is a side view of the SLM illustrated in FIG. 1;

FIG. 4 is a side view of the SLM illustrated in FIG. 1 in an example different from the example illustrated in FIG. 3B;

FIG. 5 is a flowchart of an operation of the electronic book display system illustrated in FIG. 1 in a case where display of an electronic book is started;

FIG. 6 is a diagram illustrating an example of a real-image book generated by the operation illustrated in FIG. 5;

FIG. 7A is a diagram illustrating an example different from the example illustrated in FIG. 6, of the real-image book generated by the operation illustrated in FIG. 5; FIG. 7B is a diagram illustrating an example different from the examples illustrated in FIGS. 6 and 7A, of the real-image book generated by the operation illustrated in FIG. 5;

FIG. 8A is a diagram illustrating an example of the real-image book illustrated in FIG. 6 immediately before being opened by the user's hand; FIG. 8B is a diagram illustrating an example of the real-image book illustrated in FIG. 6 being opened by the user's hand; FIG. 8C is a diagram illustrating an example of the real-image book illustrated in FIG. 6 immediately after being opened by the user's hand;

FIG. 9A is a diagram illustrating an example of the real-image book illustrated in FIG. 8C immediately before a page is turned by the user's hand; FIG. 9B is a diagram illustrating an example of the real-image book illustrated in FIG. 8C with the page being turned by the user's hand; FIG. 9C is a diagram illustrating an example of the real-image book illustrated in FIG. 8C immediately after the page is turned by the user's hand;

FIG. 10A is a diagram illustrating an example of the real-image book illustrated in FIG. 8C immediately before a plurality of pages is collectively turned by the user's hand; FIG. 10B is a diagram illustrating an example of the real-image book illustrated in FIG. 8C with the plurality of pages being collectively turned by the user's hand; FIG. 10C is a diagram illustrating an example of the real-image book illustrated in FIG. 8C immediately after the plurality of pages is collectively turned by the user's hand;

FIG. 11A is a diagram illustrating an example of the real-image book illustrated in FIG. 8C immediately before being closed by the user's hand; FIG. 11B is a diagram illustrating an example of the real-image book illustrated in FIG. 8C being closed by the user's hand; FIG. 11C is a diagram illustrating an example of the real-image book illustrated in FIG. 8C immediately after being closed by the user's hand;

FIG. 12A is a diagram illustrating an example of the real-image book illustrated in FIG. 8C immediately before the orientation is changed by the user's hand; FIG. 12B is a diagram illustrating an example of the real-image book illustrated in FIG. 8C whose orientation is being changed by the user's hand; FIG. 12C is a diagram illustrating an example of the real-image book illustrated in FIG. 8C immediately after the orientation is changed by the user's hand;

FIG. 13A is a diagram illustrating an example of the real-image book illustrated in FIG. 8C immediately before the page is broken by the user's hand; FIG. 13B is a diagram illustrating an example of the real-image book illustrated in FIG. 8C with the page being broken by the user's hand; FIG. 13C is a diagram illustrating an example of the real-image book illustrated in FIG. 8C immediately after the page is broken by the user's hand;

FIG. 14A is a diagram illustrating an example of the real-image book illustrated in FIG. 8C immediately before a page is folded by the user's hand; FIG. 14B is a diagram illustrating an example of the real-image book illustrated in FIG. 8C with the page being folded by the user's hand; FIG. 14C is a diagram illustrating an example of the real-image book illustrated in FIG. 8C immediately after the page is folded by the user's hand;

FIG. 15A is a diagram illustrating an example of the real-image book illustrated in FIG. 6 when observed by the user; FIG. 15B is a diagram illustrating an example of the real-image book illustrated in FIG. 15A when observed by a person other than the user;

FIG. 16 is a flowchart of the operation of the electronic book display system illustrated in FIG. 1 in a write mode;

FIG. 17A is a diagram illustrating an example of a page of a real-image book in which the write object is arranged based on write data illustrated in FIG. 1; FIG. 17B is a diagram illustrating an example of the page of the real-image book in which a write object is arranged based on the write data different from the write data illustrated in FIG. 1; FIG. 17C is a diagram illustrating an example of the page of the real-image book in which a write object is arranged based on the write data obtained by combining the write data illustrated in FIG. 1 and the write data illustrated in FIG. 17B;

FIG. 18A is a diagram illustrating an example of the real-image book illustrated in FIG. 6 to which a book cover is attached when observed by the user; FIG. 18B is a diagram illustrating an example of the real-image book illustrated in FIG. 18A when observed by a person other than the user;

FIG. 19 is a diagram illustrating an example of a plurality of displayed real-image books reproduced by a hologram displayed by the SLM illustrated in FIG. 1;

FIG. 20 is a diagram illustrating an example of a book shelf on which a plurality of real-image books is displayed, the book shelf being reproduced by a hologram displayed by the SLM illustrated in FIG. 1; and

FIG. 21 is a diagram illustrating an example of a plurality of stacked real-image books reproduced by a hologram displayed by the SLM illustrated in FIG. 1.

### DETAILED DESCRIPTION

Hereinafter, an embodiment of the present invention will be described with reference to the drawings.

First, a configuration of an electronic book display system according to an embodiment of the present invention will be described.

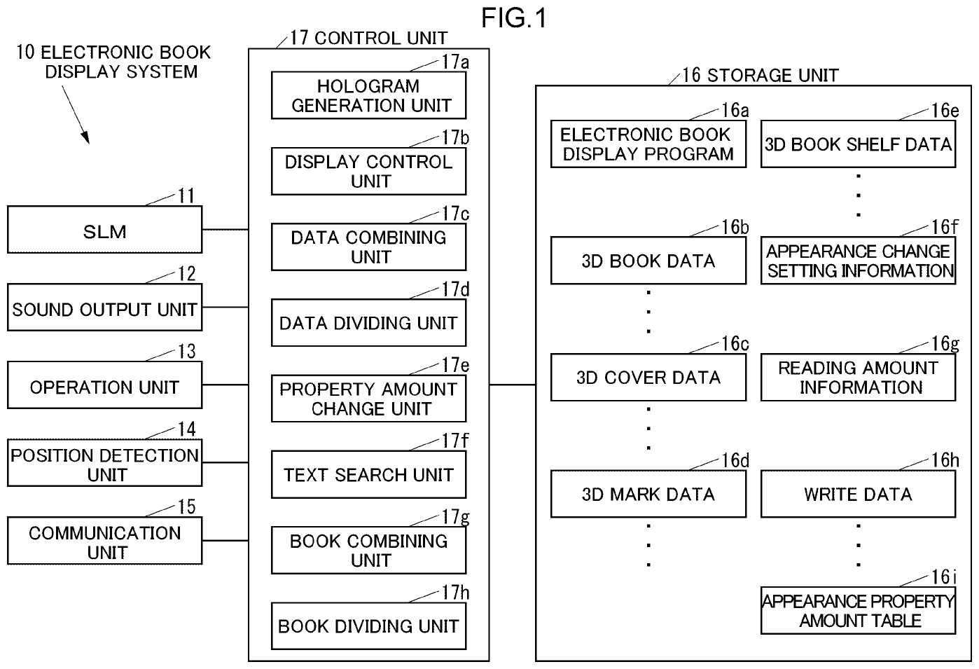

FIG. 1 is a block diagram of an electronic book display system 10 according to the present embodiment.

As illustrated in FIG. 1, the electronic book display system 10 includes a spatial light modulator (SLM) 11 that displays a hologram for electronic holography that electronically realizes holography, a sound output unit 12 that is a sound output device that outputs various information by sound, an operation unit 13 that is an operation device such as a button to which various operations are input, a position detection unit 14 that detects a position in space of an object in a region of a real image reproduced by the hologram displayed by the SLM 11 in order to detect an operation by the object such as a finger or a hand of a user with respect to the real image reproduced by the hologram displayed by the SLM 11, a communication unit 15 that is a communication device that communicates with an external device directly in a wired or wireless manner via a network such as a local area network (LAN) or the Internet or not via the network, a storage unit 16 that is a nonvolatile storage device such as a semiconductor memory that stores various types of information, and a control unit 17 that controls the entire electronic book display system 10.

The SLM 11 can be realized by, for example, a liquid crystal display (LCD), an organic EL display, or the like.

Various types of sound output units 12 can be adopted. For example, the sound output unit 12 can be realized by a speaker.

The operation unit 13 may be a unit to which an operation is input by voice.

As the position detection unit 14, various types can be adopted as long as it can detect the position of an object in the space. For example, the position detection unit 14 can be realized by a sensor that detects a direction and a distance of an object with respect to the sensor itself by irradiating a region of a real image reproduced by a hologram displayed by the SLM 11 with laser light and detecting the light reflected by the object.

The storage unit 16 stores an electronic book display program 16a for displaying an electronic book. For example, the electronic book display program 16a may be installed in the electronic book display system 10 at the manufacturing stage of the electronic book display system 10, may be additionally installed in the electronic book display system 10 from an external storage medium such as a universal serial bus (USB) memory, or may be additionally installed in the electronic book display system 10 from a network.

The storage unit 16 can store 3D book data as 3D data of an electronic book for each electronic book, such as 3D book data 16b. In the 3D book data, an amount (hereinafter, referred to as a “property amount”) of properties such as hardness and weight is defined for each component such as a component corresponding to paper forming a page in a book of a paper medium. In other words, in the electronic book, a property amount of a component of a book reproduced as an image (hereinafter, referred to as a “real-image book”) by the hologram displayed by the SLM 11 is set.

In a case where the 3D book data of the electronic book corresponding to the book on the paper medium is created, the 3D book data may be created with the same design as the book on the paper medium. In a case where 3D book data of an electronic book corresponding to a book on a paper medium is created, for example, the 3D book data may be created with a design different from that of the book on the paper medium, such as making the design of the exterior of the electronic book different from the design of the exterior of the book on the paper medium, or making the position of page switching in the sentences on the electronic book different from the position of page switching in the sentences on the book on the paper medium.

In a case where the 3D book data includes the information indicating the association between the target electronic book of the 3D book data and another electronic book, the another electronic book associated with the target electronic book can also be reproduced as a real-image book according to an instruction to the operation unit 13 by the user while the target electronic book of the 3D book data is being reproduced as a real-image book. In a case where the 3D book data includes information indicating association between a page in the target electronic book of the 3D book data and another electronic book, the another electronic book associated with the page can also be reproduced as a real-image book according to an instruction to the operation unit 13 by the user while the page is being reproduced as a real image. In a case where the 3D book data includes information indicating the association between an element such as a sentence, a character, or a figure in a page in the target electronic book of the 3D book data and another electronic book, the another electronic book associated with the element can also be reproduced as a real-image book according to an instruction to the operation unit 13 by the user while the element is being reproduced as a real image.

In a case where the 3D book data includes information indicating association between the target electronic book of the 3D book data and information such as an image and a sound, the information associated with the electronic book can also be reproduced as a real image or output as a sound by the sound output unit 12 according to an instruction to the operation unit 13 by the user while the target electronic book of the 3D book data is being reproduced as a real-image book. In a case where the 3D book data includes information indicating association between a page in the target electronic book of the 3D book data and information such as an image and a sound, the information associated with the page can also be reproduced as a real image or output as a sound by the sound output unit 12 according to an instruction to the operation unit 13 by the user while the page is reproduced as a real image. In a case where the 3D book data includes information indicating association between an element such as a sentence, a character, or a figure in a page in the target electronic book of the 3D book data and information such as an image or a sound, the information associated with the element can also be reproduced as a real image or output as a sound by the sound output unit 12 according to an instruction to the operation unit 13 by the user while the element is reproduced as a real image.

In a case where the 3D book data includes information indicating association between a page in the target electronic book of the 3D book data and another electronic book, the electronic book associated with the page can also be stereoscopically displayed as a real-image book in the page while the page is reproduced as a real image. An electronic book stereoscopically displayed as a real-image book in an electronic book reproduced as a real-image book can also be a target of various operations described later on the real-image book, such as an operation of turning a page. In a case where the 3D book data includes information indicating association between a page in the target electronic book of the 3D book data and an image, the image associated with the page can also be displayed as it is in the page while the page is reproduced as a real image.

The storage unit 16 can store 3D cover data as 3D data of a book cover covering at least a part of the exterior of the real-image book for each book cover such as the 3D cover data 16c.

The storage unit 16 can store 3D mark data as 3D data of a member for marking (hereinafter, “marking member”) such as a bookmark or a tag for each marking member such as the 3D mark data 16d. The marking member may be three-dimensional or planar.

The storage unit 16 can store 3D book shelf data as 3D data of a book shelf such as 3D book shelf data 16e for each book shelf.

The storage unit 16 can store appearance change setting information 16f indicating a setting related to an operation of changing the appearance of the real-image book according how much the electronic book read by the user (hereinafter, referred to as “a reading amount”), and reading amount information 16g indicating the reading amount for each electronic book. For example, as the reading amount, there may be various types of information such as how many times or how long the user has read the electronic book. In the following, as the reading amount, the number of times the user has read the electronic book will be described as an example. The appearance change setting information 16f includes, for example, a setting as to whether or not to change the appearance of the real-image book according to the reading amount and a setting of the type of appearance to be changed according to the reading amount. Examples of the type of appearance to be changed according to the reading amount include finger marks added to a portion such as edges in a real-image book, and deformation of the real-image book. As the deformation of the real-image book, for example, there are curvature of the real-image book, a broken page of the real-image book, and a folded page of the real-image book. For example, a hologram generation unit 17a to be described later can update the content of the appearance change setting information 16f according to an instruction input to the operation unit 13.

As operation modes of the electronic book display system 10, there are a normal mode that does not allow writing to a real-image book, and a write mode that allows writing an object such as a highlight, a red underline, a figure, or a handwritten character (hereinafter, referred to as a “write object”) to a real-image book. For example, there is a case where the user desires to read the real-image book while executing writing on the page of the real-image book in order to improve fixing of the user's own memory for the display content of the page of the real-image book. In addition, there is a case where the user desires to read the real-image book as drawing lines such as highlights or red underlines on the page of the real-image book. The storage unit 16 can store a plurality of pieces of write data such as the write data 16h as data for the write mode. The write data is data indicating which write object is arranged at which position on which page in the electronic book. The storage unit 16 can store write data for each electronic book. The storage unit 16 can store a plurality of pieces of write data for the same electronic book. For example, the user can generate writing data for each use such as write data for learning and write data for business for the same electronic book.

The storage unit 16 can store an appearance property amount table 16i indicating a correspondence relationship between the appearance of the real-image book and the property amount of the component of the real-image book. In the appearance property amount table 16i, for example, in a case where the real-image book has the appearance in which the component forming the page is a stone plate, the weight of the component forming the page may be set to be heavier than in a case where the real-image book has the appearance in which the component forming the page is paper.

The control unit 17 is, for example, a computer including a central processing unit (CPU), a read only memory (ROM) that stores programs and various data, and a random access memory (RAM) as a memory used as a work area of the CPU of the control unit 17. The CPU of the control unit 17 executes a program stored in the storage unit 16 or the ROM of the control unit 17.

By executing the electronic book display program 16a, the control unit 17 realizes the hologram generation unit 17a that generates a hologram for reproducing an electronic book as a stereoscopic image of the book, a display control unit 17b that causes the SLM 11 to display the hologram generated by the hologram generation unit 17a, a data combining unit 17c that combines a plurality of pieces of write data, a data dividing unit 17d that divides the write data, a property amount change unit 17e that changes a property amount set in the electronic book, a text search unit 17f that executes text search in the electronic book, a book combining unit 17g that combines a plurality of electronic books, and a book dividing unit 17h that divides the electronic book.

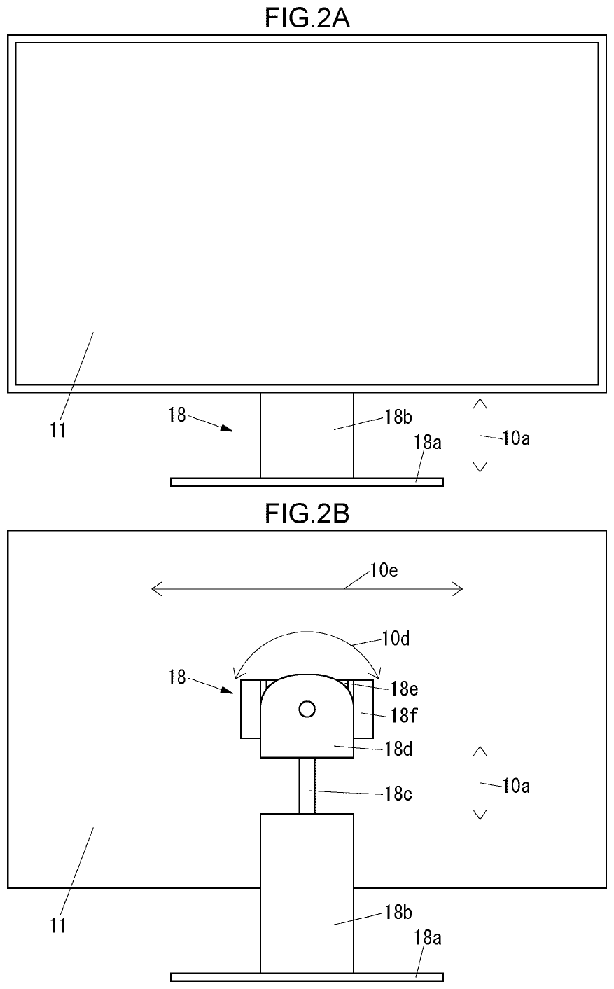

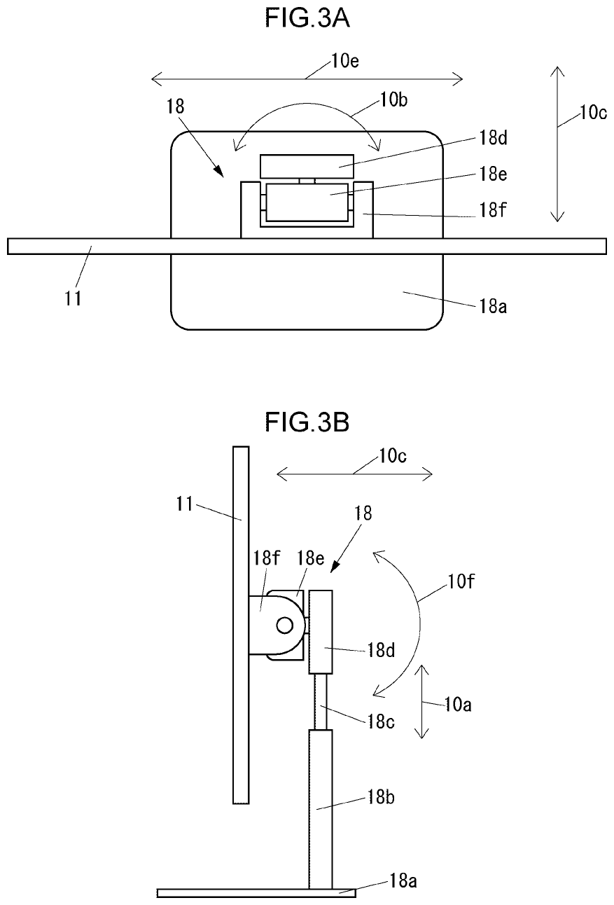

FIG. 2A is a front view of the SLM 11. FIG. 2B is a rear view of the SLM 11. FIG. 3A is a top view of the SLM 11. FIG. 3B is a side view of the SLM 11.

As illustrated in FIGS. 2A to 3B, the electronic book display system 10 includes a stand 18 that supports the SLM 11.

The stand 18 includes a base member 18a installed on a floor or the like, a member 18b extending in a direction indicated by the arrow 10a orthogonal to an installation surface of the base member 18a and attached to the base member 18a, a member 18c partially accommodated in the member 18b and movable in a direction indicated by the arrow 10a with respect to the member 18b, a member 18d supported by the member 18c so as to be rotatable in a rotation direction indicated by the arrow 10b about a rotation axis extending in the direction indicated by the arrow 10a, a member 18e supported by the member 18d so as to be rotatable in a rotation direction indicated by the arrow 10d about a rotation axis extending in the direction indicated by the arrow 10c orthogonal to the direction indicated by the arrow 10a, and, a member 18f supported by the member 18e so as to be rotatable in a rotation direction indicated by the arrow 10f about a rotation axis extending in a direction indicated by the arrow 10e orthogonal to both the direction indicated by the arrow 10a and the direction indicated by the arrow 10c. The member 18f is fixed to the SLM 11.

The stand 18 can change the position of the SLM 11 in the direction indicated by the arrow 10a by changing the position of the member 18c with respect to the member 18b in the direction indicated by the arrow 10a. In addition, the stand 18 can change the orientation of the screen of the SLM 11 by changing the angle of the member 18d with respect to the member 18c in the rotation direction indicated by the arrow 10b, the angle of the member 18e with respect to the member 18d in the rotation direction indicated by the arrow 10d, and the angle of the member 18f with respect to the member 18e in the rotation direction indicated by the arrow 10f.

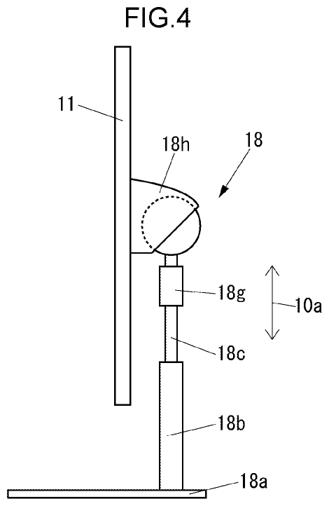

FIG. 4 is a side view of the SLM 11 in an example different from the example illustrated in FIG. 3B.

In the stand 18, the member 18d, the member 18e, and the member 18f illustrated in FIG. 3B may be replaced with a member 18g and a member 18h illustrated in FIG. 4.

The member 18g is supported by the member 18c so as to be rotatable in a rotation direction indicated by the arrow 10b (see FIG. 3A). The member 18h is fixed to the SLM 11. The member 18h is supported by the member 18g via a ball joint mechanism.

Next, an operation of the electronic book display system 10 will be described.

First, an operation of the electronic book display system 10 in a case where display of an electronic book is started will be described.

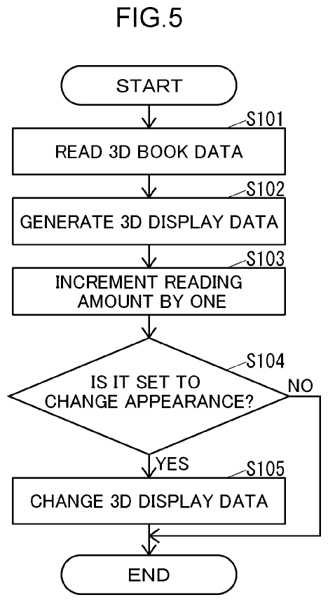

FIG. 5 is a flowchart of an operation of the electronic book display system 10 in a case where display of an electronic book is started.

The user can input an instruction to display an electronic book (hereinafter, referred to as “book display instruction”) to the operation unit 13. In the book display instruction, the electronic book selected by the user is designated.

When the book display instruction is input to the operation unit 13, the hologram generation unit 17a executes the operation illustrated in FIG. 5.

As illustrated in FIG. 5, the hologram generation unit 17a reads the 3D book data of the electronic device designated in the book display instruction from the storage unit 16 (S101).

Upon completion of the processing of S101, the hologram generation unit 17a generates 3D data (hereinafter, referred to as “3D display data”) for displaying a hologram (S102). In S102, the hologram generation unit 17a generates 3D display data including the 3D book data read in S101.

The hologram generation unit 17a generates a hologram for reproducing a real image based on the 3D display data each time the 3D display data is generated or changed. The display control unit 17b causes the SLM 11 to display the hologram generated by the hologram generation unit 17a every time the hologram is generated by the hologram generation unit 17a. Hereinafter, description of generating a hologram for reproducing a real image based on the 3D display data and displaying the hologram by the SLM 11 will be omitted.

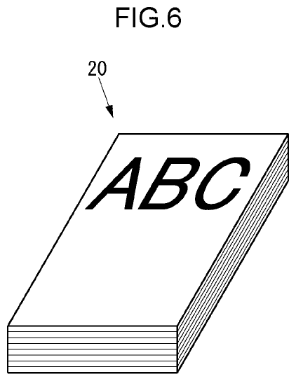

FIG. 6 is a diagram illustrating an example of a real-image book 20 generated by the operation illustrated in FIG. 5.

After the hologram generation unit 17a generates the 3D display data in S102, the hologram based on the 3D display data is displayed by the SLM 11, and thus, for example, the real-image book 20 illustrated in FIG. 6 is generated by the hologram displayed by the SLM 11.

As illustrated in FIG. 5, when the processing of S102 is completed, the hologram generation unit 17a increments the reading amount indicated in the reading amount information 16g for the electronic book corresponding to the 3D book data included in the 3D display data by one (S103).

Upon completion of the processing of S103, the hologram generation unit 17a determines whether or not it is set to change the appearance of the real-image book according to the reading amount in the appearance change setting information 16f (S104).

When determining in S104 that it is set to change the appearance of the real-image book according to the reading amount in the appearance change setting information 16f, the hologram generation unit 17a changes the 3D display data so that the type of appearance set in the appearance change setting information 16f corresponds to the reading amount indicated in the reading amount information 16g for the electronic book corresponding to the 3D book data included in the 3D display data (S105). For example, in a case where the type of appearance set in the appearance change setting information 16f is finger marks, the hologram generation unit 17a changes the 3D display data so that the more finger marks are added to the real-image book, the more the reading amount is. Furthermore, in a case where the type of appearance set in the appearance change setting information 16f is the deformation of the real-image book, the hologram generation unit 17a changes the 3D display data such that the larger the deformation of the real-image book, the larger the reading amount. Therefore, the appearance of the real-image book corresponds to the reading amount.

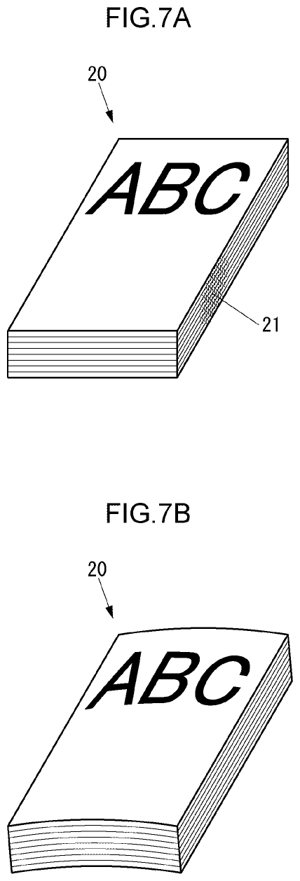

FIG. 7A is a diagram illustrating an example different from the example illustrated in FIG. 6, of the real-image book 20 generated by the operation illustrated in FIG. 5. FIG. 7B is a diagram illustrating an example different from the examples illustrated in FIGS. 6 and 7A, of the real-image book 20 generated by the operation illustrated in FIG. 5.

The example of the real-image book 20 illustrated in FIG. 7A is an example in a case where the type of appearance set in the appearance change setting information 16f is finger marks. In the real-image book 20 illustrated in FIG. 7A, the finger marks 21 are expressed.

The example of the real-image book 20 illustrated in FIG. 7B is an example in a case where the type of appearance set in the appearance change setting information 16f is the curvature of the real-image book. The real-image book 20 illustrated in FIG. 7B is curved.

As illustrated in FIG. 5, the operation illustrated in FIG. 5 is ended when the hologram generation unit 17a determines in S104 that changing the appearance of the real-image book according to the reading amount is not set in the appearance change setting information 16f or when the processing of S105 is ended.

The hologram generation unit 17a can change the 3D display data according to the instruction input to the operation unit 13 in order to change at least one of the size and the brightness of the real-image book. For example, when the characters displayed on the real-image book are small and difficult to read, the user can enlarge the characters displayed on the real-image book by increasing the size of the real-image book. In addition, in a case where the size of the real-image book is too large or too small and it is difficult for the user to operate the real-image book, it is possible to improve the operability of the real-image book by changing the size of the real-image book.

The hologram generation unit 17a can change the 3D display data according to the instruction input to the operation unit 13 in order to change at least one of the font and the size of the characters displayed on the real-image book.

Next, an operation of the electronic book display system 10 in a case where an operation on the real-image book is input will be described.

When the position detection unit 14 detects the user's operation on the real-image book, the hologram generation unit 17a changes the 3D display data according to the operation detected by the position detection unit 14. When changing the 3D display data according to the operation detected by the position detection unit 14, the hologram generation unit 17a changes the 3D display data based on, for example, the magnitude and direction of the force according to the operation detected by the position detection unit 14 and the property amount included in the 3D display data. Therefore, the real-image book operates according to the operation detected by the position detection unit 14.

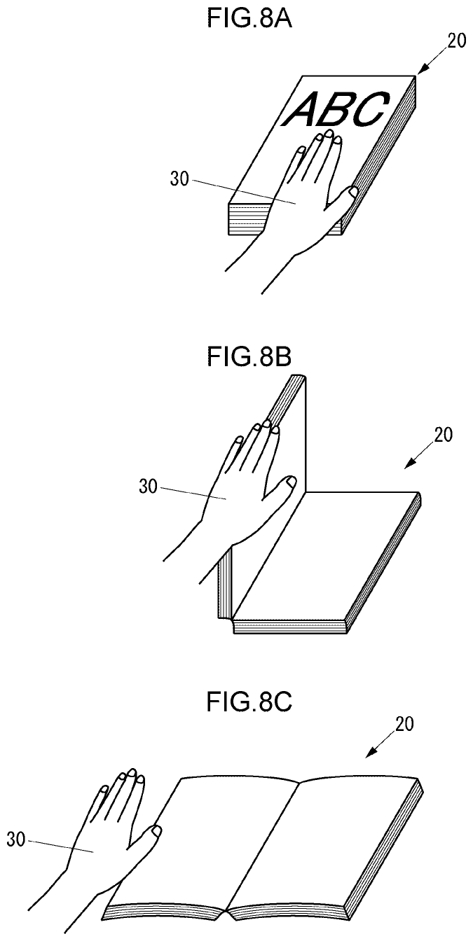

FIG. 8A is a diagram illustrating an example of the real-image book 20 immediately before being opened by the user's hand 30. FIG. 8B is a diagram illustrating an example of the real-image book 20 being opened by the user's hand 30. FIG. 8C is a diagram illustrating an example of the real-image book 20 immediately after being opened by the user's hand 30.

For example, in a case where the position detection unit 14 detects that the operation similar to the operation of opening the book on the paper medium is input to the real-image book, the hologram generation unit 17a gradually changes the 3D display data according to the lapse of time such that the operation similar to the operation of opening the book on the paper medium occurs in the real-image book when the operation of opening the book on the paper medium is executed. Therefore, for example, the real-image book 20 illustrated in FIG. 6 is opened according to the operation by the hand 30 of the user as illustrated in FIGS. 8A to 8C.

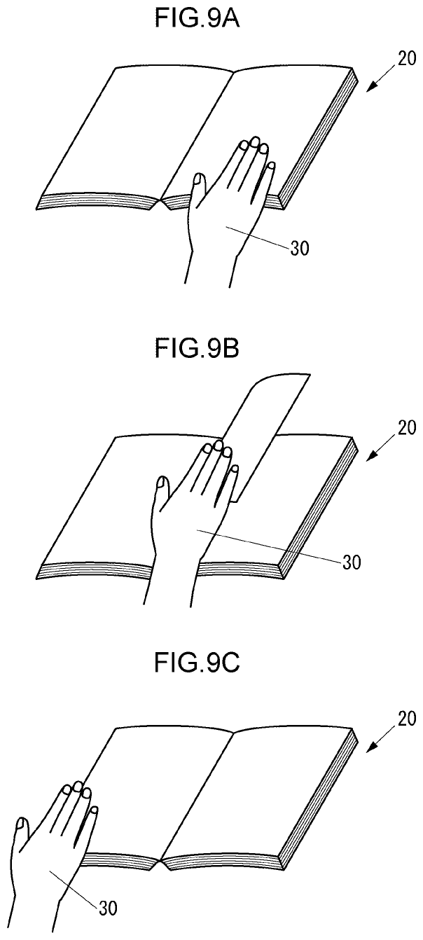

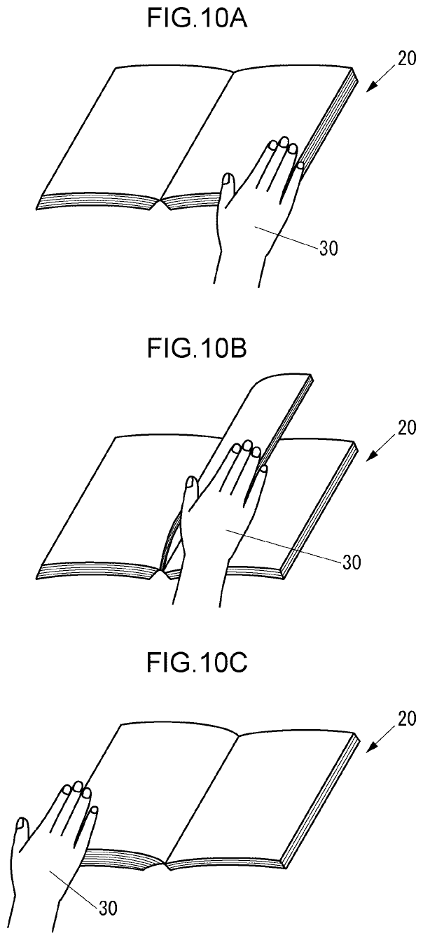

FIG. 9A is a diagram illustrating an example of the real-image book 20 immediately before a page is turned by the user's hand 30. FIG. 9B is a diagram illustrating an example of the real-image book 20 with the page being turned by the user's hand 30. FIG. 9C is a diagram illustrating an example of the real-image book 20 immediately after the page is turned by the user's hand 30. FIG. 10A is a diagram illustrating an example of the real-image book 20 immediately before a plurality of pages is collectively turned by the user's hand 30. FIG. 10B is a diagram illustrating an example of the real-image book 20 with the plurality of pages being collectively turned by the user's hand 30. FIG. 10C is a diagram illustrating an example of the real-image book 20 immediately after the plurality of pages is collectively turned by the user's hand 30.

For example, in a case where the position detection unit 14 detects that the operation similar to the operation of turning the page of the book on the paper medium is input to the real-image book, the hologram generation unit 17a gradually changes the 3D display data according to the lapse of time such that the operation similar to the operation of turning the page of the book on the paper medium occurs in the real-image book when the operation of turning the page of the book on the paper medium is executed. Therefore, for example, as illustrated in FIGS. 9A to 9C or FIGS. 10A to 10C, the real-image book 20 illustrated in FIG. 8C is paged according to the operation by the hand 30 of the user. The operation of turning pages may be an operation of turning pages one by one as illustrated in FIGS. 9A to 9C, or may be an operation of collectively turning a plurality of pages at a time as illustrated in FIGS. 10A to 10C. The hologram generation unit 17a may generate a hologram so that the page of the real-image book is turned at a speed corresponding to the property amount included in the 3D book data included in the 3D display data. For example, the hologram generation unit 17a may generate the hologram such that the page of the real-image book is turned at a higher speed as the weight of the component forming the page of the real-image book is heavier.

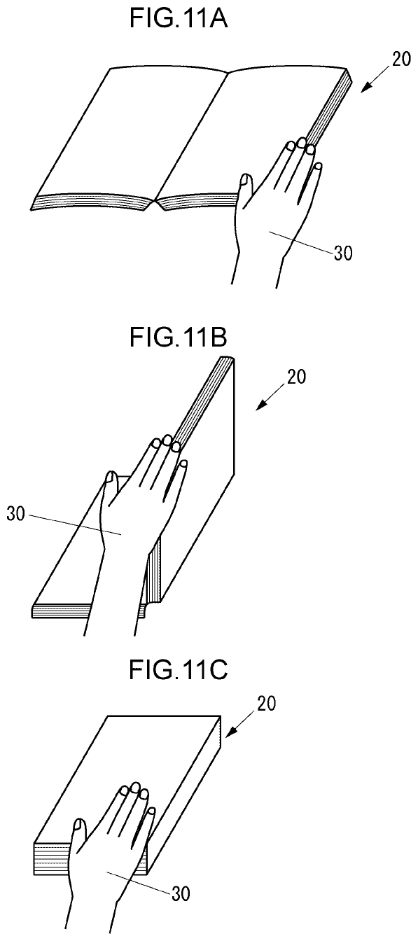

FIG. 11A is a diagram illustrating an example of the real-image book 20 immediately before being closed by the user's hand 30. FIG. 11B is a diagram illustrating an example of the real-image book 20 being closed by the user's hand 30. FIG. 11C is a diagram illustrating an example of the real-image book 20 immediately after being closed by the user's hand 30.

For example, in a case where the position detection unit 14 detects that the operation similar to the operation of closing the book on the paper medium is input to the real-image book, the hologram generation unit 17a gradually changes the 3D display data according to the lapse of time such that the operation similar to the operation of closing the book on the paper medium occurs in the real-image book when the operation of closing the book on the paper medium is executed. Therefore, for example, the real-image book 20 illustrated in FIG. 8C is closed according to the operation by the hand 30 of the user as illustrated in FIGS. 11A to 11C.

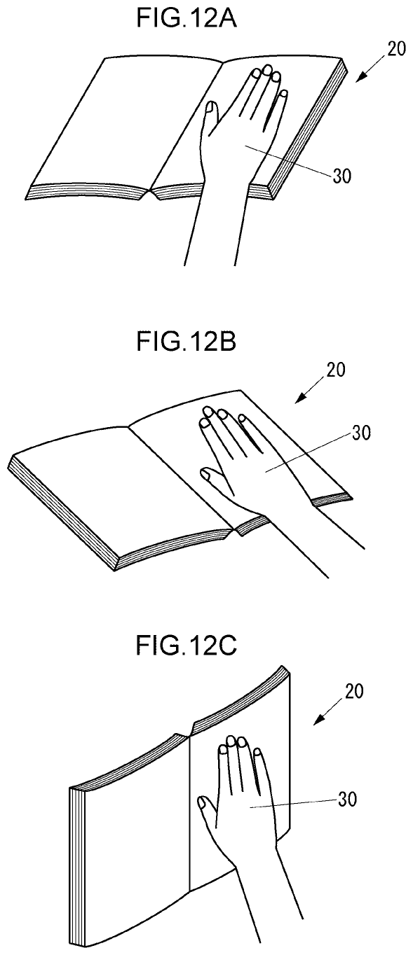

FIG. 12A is a diagram illustrating an example of the real-image book 20 immediately before the orientation is changed by the user's hand 30. FIG. 12B is a diagram illustrating an example of the real-image book 20 whose orientation is being changed by the user's hand 30. FIG. 12C is a diagram illustrating an example of the real-image book 20 immediately after the direction is changed by the user's hand 30.

For example, in a case where the position detection unit 14 detects that the operation similar to the operation of changing the orientation of the book on the paper medium is input to the real-image book, the hologram generation unit 17a gradually changes the 3D display data in accordance with the lapse of time such that the operation similar to the operation of changing the orientation of the book on the paper medium occurs in the real-image book when the operation of changing the orientation of the book on the paper medium is executed. Therefore, for example, the orientation of the real-image book 20 illustrated in FIG. 8C is changed according to the operation by the hand 30 of the user as illustrated in FIGS. 12A to 12C.

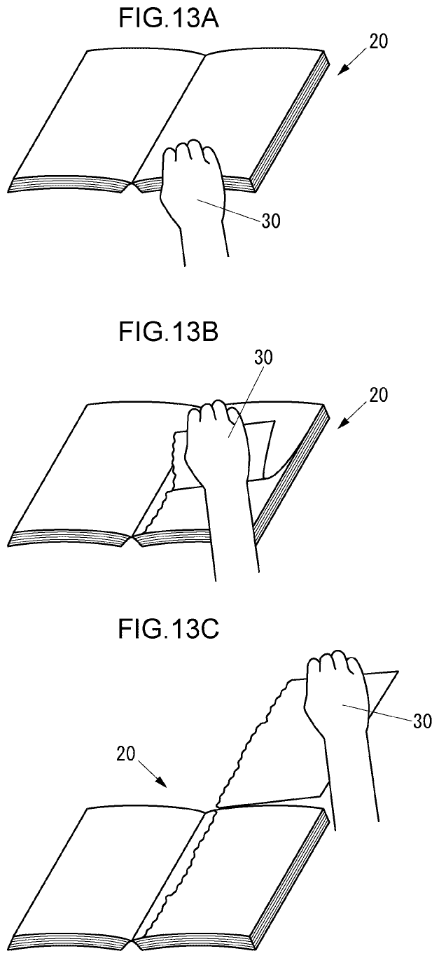

FIG. 13A is a diagram illustrating an example of the real-image book 20 immediately before the page is broken by the user's hand 30. FIG. 13B is a diagram illustrating an example of the real-image book 20 with the page being broken by the user's hand 30. FIG. 13C is a diagram illustrating an example of the real-image book 20 immediately after the page is broken by the user's hand 30.

For example, in a case where the position detection unit 14 detects that the operation similar to the operation of breaking the page of the book on the paper medium is input to the real-image book, the hologram generation unit 17a gradually changes the 3D display data according to the lapse of time such that the operation similar to the operation of breaking the page of the book on the paper medium occurs in the real-image book when the operation of breaking the page of the book on the paper medium is executed. Therefore, for example, in the real-image book 20 illustrated in FIG. 8C, the page is broken according to the operation by the hand 30 of the user as illustrated in FIGS. 13A to 13C. For example, the user can visually obtain a sense of achievement of reading by breaking a page read by the user himself/herself out of pages in the real-image book.

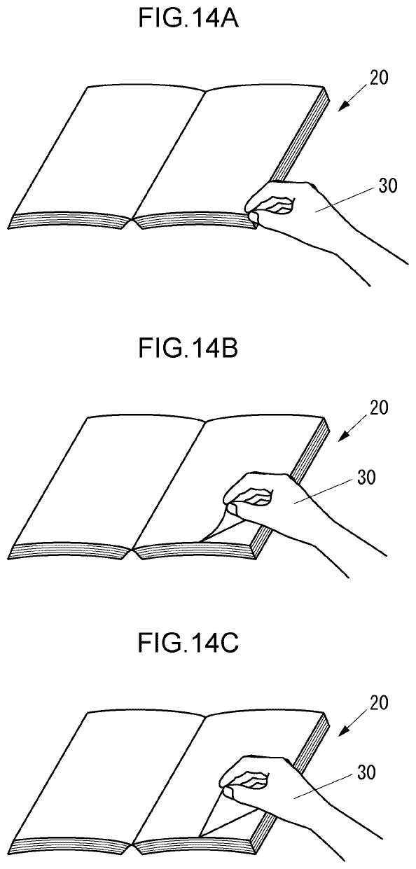

FIG. 14A is a diagram illustrating an example of the real-image book 20 immediately before a page is folded by the user's hand 30. FIG. 14B is a diagram illustrating an example of the real-image book 20 with the page being folded by the user's hand 30. FIG. 14C is a diagram illustrating an example of the real-image book 20 immediately after the page is folded by the user's hand 30.

For example, in a case where the position detection unit 14 detects that the operation similar to the operation of folding the page of the book on the paper medium is input to the real-image book, the hologram generation unit 17a gradually changes the 3D display data according to the lapse of time such that the operation similar to the operation of folding the page of the book on the paper medium occurs in the real-image book when the operation of folding the page of the book on the paper medium is executed. Therefore, for example, in the real-image book 20 illustrated in FIG. 8C, the page is folded according to the operation by the hand 30 of the user as illustrated in FIGS. 14A to 14C. For example, the user can easily find the page that the user had been focused later by creasing, as a mark, the page that the user has been focused among the pages in the real-image book.

When changing the 3D display data, the hologram generation unit 17a may output a sound according to the change of the 3D display data from the sound output unit 12. For example, in a case where the 3D display data is changed so that the real-image book is opened, the hologram generation unit 17a may output a sound similar to a sound generated in a case where a book on a paper medium is opened from the sound output unit 12 according to how the real-image book is opened. In addition, when changing the 3D display data so that a page of the real-image book is turned, the hologram generation unit 17a may output a sound similar to a sound generated when a page of a book on a paper medium is turned from the sound output unit 12 according to the how the page of the real-image book is turned. Furthermore, in a case where the 3D display data is changed so that the real-image book is closed, the hologram generation unit 17a may output a sound similar to a sound generated in a case where a book on a paper medium is closed from the sound output unit 12 according to how the real-image book is closed.

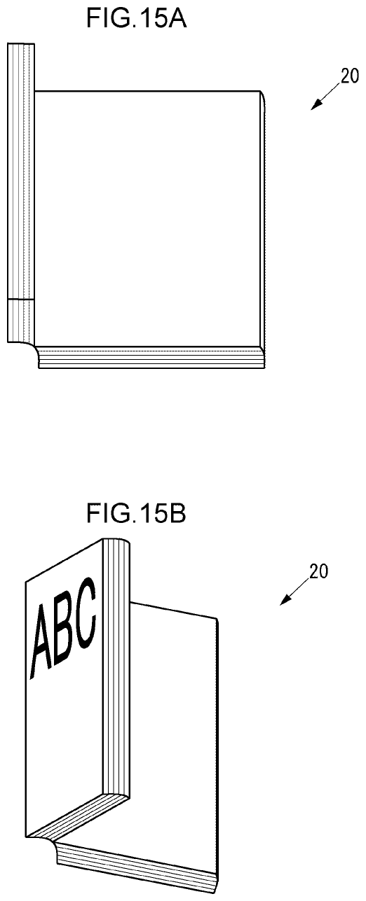

FIG. 15A is a diagram illustrating an example of the real-image book 20 when observed by the user. FIG. 15B is a diagram illustrating an example of the real-image book 20 illustrated in FIG. 15A when observed by a person other than the user.

In a case where the display content of the page of the real-image book 20 is visible from the viewpoint of the user with respect to the SLM 11 as illustrated in FIG. 15A, the hologram generation unit 17a can generate a hologram in which the front exterior of the entire exterior of the real-image book 20 that is not visible from the viewpoint of the user is visible from the viewpoint of a person other than the user with respect to the SLM 11 as illustrated in FIG. 15B. Therefore, when the display content of the page of the real-image book 20 is seen from the viewpoint of the user with respect to the SLM 11 as illustrated in FIG. 15A, the electronic book display system 10 can display, by the SLM 11 as illustrated in FIG. 15B, a hologram in which the front exterior of the entire exterior of the real-image book 20 that is not visible from the viewpoint of the user is visible from the viewpoint of the person other than the user with respect to the SLM 11. Although the front exterior is described, the same applies to the rear exterior and the spine exterior. That is, in a case where the display content of the page of the real-image book 20 is visible from the viewpoint of the user with respect to the SLM 11, the electronic book display system 10 can display, by the SLM 11, a hologram in which at least a part of an area of the exterior of the real-image book 20 that is not visible from the viewpoint of the user is visible from the viewpoint of a person other than the user with respect to the SLM 11.

Next, an operation of the electronic book display system 10 in the write mode will be described.

In a case where the operation mode of the electronic book display system 10 is the normal mode, when the real-image book is being reproduced, the user can input, to the operation unit 13, an instruction to shift the operation mode of the electronic book display system 10 from the normal mode to the write mode (hereinafter, referred to as a “write mode shift instruction”). In the write mode shift instruction, the write data selected by the user among the write data for the current real-image book stored in the storage unit 16 can be designated.

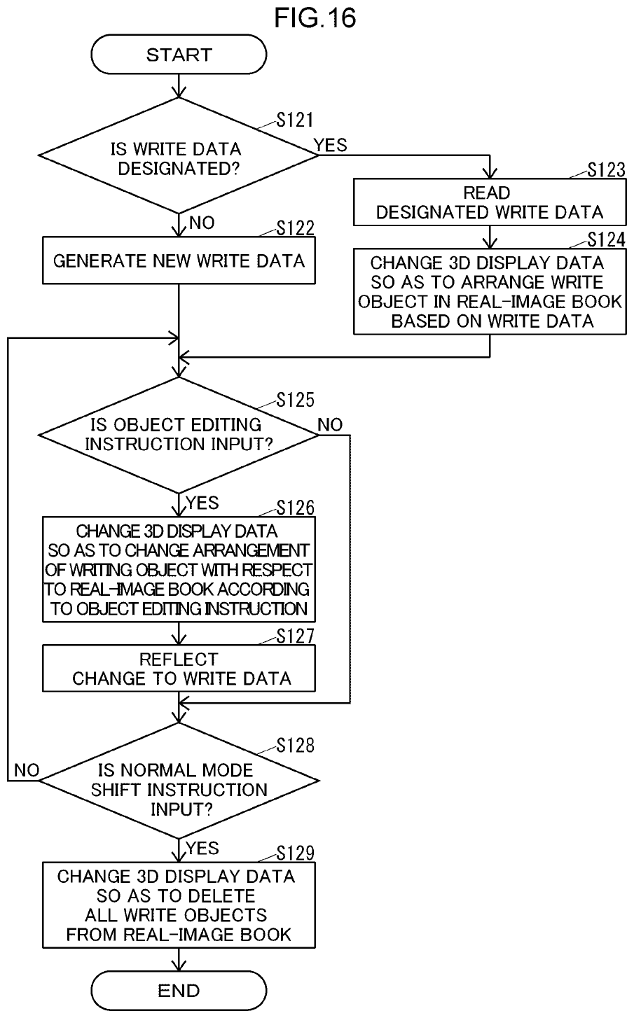

FIG. 16 is a flowchart of the operation of the electronic book display system 10 in the write mode.

When the write mode shift instruction is input to the operation unit 13, the hologram generation unit 17a executes the operation illustrated in FIG. 16.

As illustrated in FIG. 16, the hologram generation unit 17a determines whether or not write data is designated in the write mode shift instruction input to the operation unit 13 (S121).

When determining that the write data is not designated in the write mode shift instruction input to the operation unit 13 in S121, the hologram generation unit 17a generates new write data for the current real-image book in the storage unit 16 (S122).

When determining that the write data is designated in the write mode shift instruction input to the operation unit 13 in S121, the hologram generation unit 17a reads the write data designated in the write mode shift instruction from the storage unit 16 (S123).

Upon completion of the processing of S123, the hologram generation unit 17a changes the 3D display data so as to arrange the write object in the current real-image book based on the write data read in S123 (S124). Therefore, the write object is arranged in the current real-image book based on the write data read in S123.

Upon completion of the processing of S122 or S124, the hologram generation unit 17a determines whether an instruction to edit the write object for the current real-image book (hereinafter, referred to as “object editing instruction”) has been input to the operation unit 13 or the position detection unit 14 (S125). The editing of the write object includes, for example, arranging a new write object in the real-image book, changing the position of any one of the write objects arranged in the real-image book, and deleting any one of the write objects arranged in the real-image book from the real-image book.

When determining in S125 that the object editing instruction is input to the operation unit 13 or the position detection unit 14, the hologram generation unit 17a changes the 3D display data so as to change the arrangement of the write object with respect to the real-image book according to the object editing instruction input to the operation unit 13 or the position detection unit 14 (S126). Therefore, the arrangement of the write object in the real-image book follows the object editing instruction.

Upon completion of the processing of S126, the hologram generation unit 17a reflects the change in the arrangement of the write objects for the real-image book, which has been executed in S126, on the target write data in the storage unit 16 (S127). The target write data is the write data generated in S122 when the write data is not designated in the write mode shift instruction, and is the write data designated in the write mode shift instruction when the write data is designated in the write mode shift instruction.

When determining in S125 that an object editing instruction has not been input to the operation unit 13 or the position detection unit 14 or when the processing of S127 is ended, the hologram generation unit 17a determines whether an instruction to shift the operation mode of the electronic book display system 10 from the write mode to the normal mode (hereinafter referred to as “normal mode shift instruction”) has been input to the operation unit 13 (S128).

When determining in S128 that the normal mode shift instruction has not been input to the operation unit 13, the hologram generation unit 17a executes the processing of S125. When determining in S128 that the normal mode shift instruction is input to the operation unit 13, the hologram generation unit 17a changes the 3D display data so as to delete all the write objects from the current real-image book (S129). Therefore, in the real-image book, the write object is not arranged at all.

Upon completion of the processing of S129, the hologram generation unit 17a terminates the operation illustrated in FIG. 16.

Next, an operation of the electronic book display system 10 in a case of combining a plurality of pieces of write data will be described.

The user can input an instruction to combine a plurality of pieces of write data (hereinafter, referred to as “data combining instruction”) to the operation unit 13. In the data combining instruction, a plurality of pieces of write data selected by the user is designated. The plurality of pieces of write data designated in the data combining instruction is pieces of write data for the same electronic book.

When the data combining instruction is input to the operation unit 13, the data combining unit 17c reads the plurality of pieces of write data designated in the data combining instruction from the storage unit 16. Next, the data combining unit 17c combines the plurality of pieces of write data read from the storage unit 16 to generate one piece of write data. Then, the data combining unit 17c writes the write data generated by the combining in the storage unit 16 as new write data for the target electronic book of the plurality of pieces of write data before the combining.

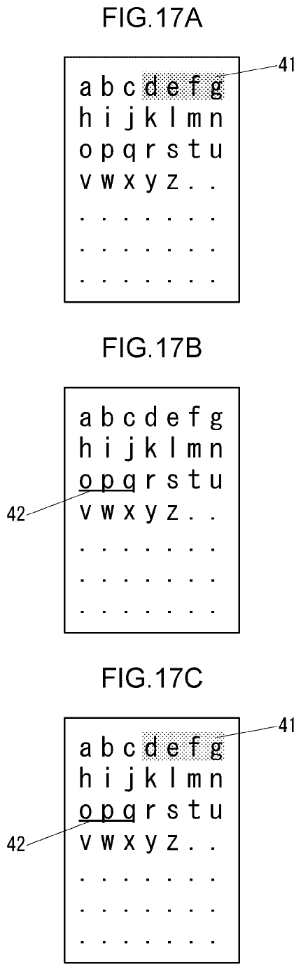

FIG. 17A is a diagram illustrating an example of a page of a real-image book in which the write object is arranged based on the write data 16h (see FIG. 1). FIG. 17B is a diagram illustrating an example of the page of the real-image book in which a write object is arranged based on the write data different from the write data 16h. FIG. 17C is a diagram illustrating an example of the page of the real-image book in which write objects are arranged based on the write data obtained by combining the write data 16h and the write data illustrated in FIG. 17B.

The page illustrated in FIG. 17A, the page illustrated in FIG. 17B, and the page illustrated in FIG. 17C are the same page in the same real-image book.

In the page illustrated in FIG. 17A, a highlight 41 is arranged as a write object based on the write data 16h.

In the page illustrated in FIG. 17B, a red underline 42 is arranged as write object based on the write data different from the write data 16h.

The page illustrated in FIG. 17C is the page of the real-image book in which the write objects are arranged based on the write data obtained by combining the write data 16h illustrated in FIG. 17A and the write data illustrated in FIG. 17B. In the page illustrated in FIG. 17C, the highlight 41 illustrated in FIG. 17A is included at the position illustrated in FIG. 17A, and the red underline 42 illustrated in FIG. 17B is included at the position illustrated in FIG. 17B.

Next, an operation of the electronic book display system 10 in a case where the write data is divided will be described.

The user can input an instruction to divide the write data (hereinafter, referred to as a “data dividing instruction”) to the operation unit 13. In the data dividing instruction, write data selected by the user and a dividing condition in the write data are specified. As the dividing condition specified in the data dividing instruction, for example, an arbitrary condition such as an object type can be specified. For example, the dividing condition specified in the data dividing instruction is a condition that the highlight as the write object and the red underline as the write object are divided into separate pieces of write data.

When the data dividing instruction is input to the operation unit 13, the data dividing unit 17d reads the write data designated by the data dividing instruction from the storage unit 16. Next, the data dividing unit 17d divides the write data read from the storage unit 16 under the condition specified in the data dividing instruction to generate a plurality of pieces of write data. Then, the data dividing unit 17d writes, in the storage unit 16, each of the plurality of pieces of write data generated by dividing as new pieces of write data for the electronic book as a target of the write data before the dividing.

Next, an operation of the electronic book display system 10 in a case where the page of the real-image book is automatically turned will be described.

When an instruction to automatically turn the page of the real-image book (hereinafter, referred to as an “automatic turning instruction”) is input to the operation unit 13, the hologram generation unit 17a gradually changes the 3D display data according to the lapse of time such that an operation similar to the operation of turning the page of the book on the paper medium occurs in the real-image book when the operation of turning the page of the book on the paper medium is executed. Therefore, the real-image book automatically turns the page according to the automatic turning instruction input to the operation unit 13 by the user. In a case where the hologram generation unit 17a changes the 3D display data according to the automatic turning instruction, for example, the hologram generation unit 17a may change the 3D display data based on the property amount included in the 3D book data included in the 3D display data. In other words, the hologram generation unit 17a may generate a hologram so that the page of the real-image book is turned at a speed corresponding to the property amount included in the 3D book data included in the 3D display data. For example, the hologram generation unit 17a may generate the hologram such that the page of the real-image book is turned at a higher speed as the weight of the component forming the page of the real-image book is heavier.

The user can designate the speed at which the page is automatically turned in the automatic turning instruction. In a case where the automatic page turning speed is specified in the automatic turning instruction, when changing the display 3D data according to the automatic turning instruction, the hologram generation unit 17a gradually changes the 3D display data according to the lapse of time so that the page is automatically turned at the speed specified in the automatic turning instruction.

When changing the 3D display data so that a page of the real-image book is turned, the hologram generation unit 17a may output a sound similar to a sound generated when a page of a book on a paper medium is turned from the sound output unit 12 according to the situation in which the page of the real-image book is turned.

Next, an operation of the electronic book display system 10 in a case where the appearance of the real-image book is changed according to an instruction of the user will be described.

When an instruction to change the appearance of the real-image book (hereinafter, referred to as an “appearance change instruction”) is input to the operation unit 13, the hologram generation unit 17a changes the 3D display data according to the appearance change instruction input to the operation unit 13. Therefore, the appearance of the real-image book is changed to the appearance according to the appearance change instruction input to the operation unit 13 by the user. For example, in a case where the appearance change instruction is an instruction to change the appearance of the real-image book to paperback appearance, the hologram generation unit 17a changes the 3D display data so that the appearance of the real-image book becomes paperback appearance. Similarly, in a case where the appearance change instruction is an instruction to change the appearance of the real-image book to, for example, an appearance like a hardcover book, an appearance in which a component forming the page is formed of a wood plate instead of paper, an appearance in which a component forming the page is formed of a bamboo plate instead of paper, an appearance in which a component forming the page is formed of a stone plate instead of paper, or the like, the hologram generation unit 17a changes the 3D display data such that the appearance of the real-image book becomes the appearance instructed by the appearance change instruction. In a case where the appearance change instruction is an instruction to change the appearance of the real-image book to the appearance of a design desired by the user, such as a design of a specific character, the hologram generation unit 17a changes the 3D display data such that the appearance of the real-image book becomes the appearance instructed by the appearance change instruction.

When changing the appearance of the real-image book, the hologram generation unit 17a may change the property amount included in the 3D book data included in the 3D display data to a property amount according to the changed appearance based on the appearance property amount table 16i. In other words, when changing the appearance of the real-image book, the hologram generation unit 17a may set the property amount according to the changed appearance in the electronic book.

Next, an operation of the electronic book display system 10 in a case where the property amount of the real-image book is changed according to an instruction of the user will be described.

When an instruction to change the property amount of the real-image book is input to the operation unit 13, the property amount change unit 17e changes the property amount included in the 3D book data included in the 3D display data according to the instruction input to the operation unit 13.

In a case where the page turning operation is input to the position detection unit 14 regarding the real-image book, the page turning speed of the real-image book is related to the property amount included in the 3D book data of the real-image book. Therefore, when the property amount included in the 3D book data of the real-image book is changed, if a page turning operation is input to the position detection unit 14 regarding the real-image book, there is a possibility that the page turning speed in the real-image book changes.

Next, an operation of the electronic book display system 10 in a case where the book cover is attached to the real-image book will be described.

The user can input an instruction to attach a book cover to the real-image book (hereinafter, referred to as a “cover attaching instruction”) to the operation unit 13. In the cover attaching instruction, the 3D cover data selected by the user is designated.

When the cover attaching instruction is input to the operation unit 13, the hologram generation unit 17a changes the 3D display data such that the book cover indicated by the 3D cover data designated by the cover attaching instruction input to the operation unit 13 is attached to the real-image book. That is, the hologram generation unit 17a adds the 3D cover data to the 3D display data. Therefore, the book cover corresponding to the cover attaching instruction input to the operation unit 13 by the user is attached to the real-image book.

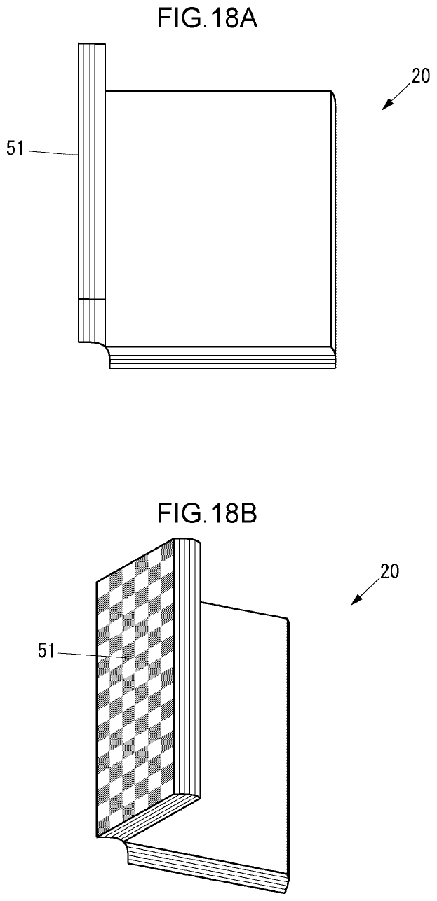

FIG. 18A is a diagram illustrating an example of the real-image book 20 to which a book cover 51 is attached when observed by the user. FIG. 18B is a diagram illustrating an example of the real-image book 20 illustrated in FIG. 18A when observed by a person other than the user.

The hologram for reproducing the image illustrated in FIGS. 18A and 18B is different from the hologram for reproducing the image illustrated in FIGS. 15A and 15B in that the book cover 51 is attached to the real-image book 20. The viewpoint with respect to the SLM 11 illustrated in FIG. 15A is the same as the viewpoint with respect to the SLM 11 illustrated in FIG. 18A. The viewpoint with respect to the SLM 11 illustrated in FIG. 15B is the same as the viewpoint with respect to the SLM 11 illustrated in FIG. 18B.

In the hologram illustrated in FIGS. 18A and 18B, the book cover 51 covers an area that is not visible from the viewpoint of the user and is visible from the viewpoint of the person other than the user in the hologram illustrated in FIGS. 15A and 15B in the exterior of the real-image book 20.

In a case where the display content of the page of the real-image book 20 is visible from the viewpoint of the user with respect to the SLM 11 as illustrated in FIG. 18A, the electronic book display system 10 can display, by the SLM 11, a hologram in which an area covering the front exterior of the real-image book 20 in the book cover 51 of the real-image book 20 is visible from the viewpoint of the person other than the user with respect to the SLM 11 as illustrated in FIG. 18B. Although the front exterior is described, the same applies to the rear exterior and the spine exterior. In other words, in a case where the display content of the page of the real-image book 20 is visible from the viewpoint of the user with respect to the SLM 11, the electronic book display system 10 can display, on the SLM 11, a hologram in which at least a part of a portion covering at least one of the front exterior, the rear exterior, and the spine exterior of the real-image book 20 in the book cover 51 of the real-image book 20 is visible from the viewpoint of the person other than the user with respect to the SLM 11.

Next, an operation of the electronic book display system 10 in a case where a marking member is added to the real-image book according to the instruction of the user will be described.

The user can input an instruction to add a marking member to the real-image book (hereinafter, referred to as a “marking member addition instruction”) to the operation unit 13 or the position detection unit 14. The 3D mark data selected by the user is designated in the marking member addition instruction.

When the marking member addition instruction is input to the operation unit 13 or the position detection unit 14, the hologram generation unit 17a changes the 3D display data such that the marking member is added to the real-image book according to the marking member addition instruction input to the operation unit 13 or the position detection unit 14. That is, the hologram generation unit 17a adds the 3D mark data to the 3D display data. Therefore, a marking member corresponding to the marking member addition instruction input to the operation unit 13 or the position detection unit 14 by the user is added to the real-image book. For example, in a case where the real-image book is an animal picture book, the user can sandwich a stereoscopic animal marking member as a bookmark between pages desired by the user in the real-image book.

Next, an operation of the electronic book display system 10 in a case where a marking member is added to a real-image book according to a result of text search for the real-image book will be described.

The text search unit 17f can execute text search on the real-image book according to the instruction input to the operation unit 13. Then, the hologram generation unit 17a changes the 3D display data so as to add the marking member to the real-image book according to the result of the text search. That is, the hologram generation unit 17a adds the 3D mark data to the 3D display data. Therefore, a marking member corresponding to the result of the text search is added to the real-image book.

For example, in a case where text search for searching the word “rice” is executed for the real-image book, the hologram generation unit 17a can add a marking member to a page including the word “rice” in the real-image book. Therefore, the user can easily recognize the page including the word “rice” in the real-image book.

Next, an operation of the electronic book display system 10 in a case where the display of the electronic book is ended will be described.

The user can input an instruction to end the display of the electronic book (hereinafter referred to as a “display end instruction”) to the operation unit 13.

When the display end instruction is input to the operation unit 13, the hologram generation unit 17a deletes the 3D display data. Therefore, the hologram displayed by the SLM 11 disappears. As a result, the real-image book disappears.

Next, an operation of the electronic book display system 10 in a case where a plurality of electronic books is combined will be described.

The user can input an instruction to combine a plurality of electronic books (hereinafter, referred to as a “book combining instruction”) to the operation unit 13. In the book combining instruction, a plurality of electronic books selected by the user is designated. The plurality of electronic books designated in the book combining instruction may be, for example, a plurality of electronic books belonging to the same series such as volume 1, volume 2, or volume 3, or may be a plurality of electronic books not belonging to the same series.

When the book combining instruction is input to the operation unit 13, the book combining unit 17g reads the 3D book data of the plurality of electronic books designated in the book combining instruction from the storage unit 16. Next, the book combining unit 17g combines the plurality of pieces of 3D book data read from the storage unit 16 to generate one piece of 3D book data so that the plurality of electronic books designated in the book combining instruction is combined into one electronic book. Then, the book combining unit 17g writes the 3D book data generated by combining to the storage unit 16 as new 3D book data.

Therefore, the user can cause the electronic book display system 10 to start displaying one electronic book obtained by combining the plurality of electronic books and read the electronic book as a real-image book. In the real-image book, the number of pages of the electronic book is expressed as a thickness. Therefore, the thickness of the real-image book of the electronic book obtained by combining the plurality of electronic books is thicker than the thickness of the real-image book of each of the plurality of electronic books before combining.

Next, an operation of the electronic book display system 10 in a case where the electronic book is divided will be described.

The user can input an instruction to divide the electronic book (hereinafter, referred to as a “book dividing instruction”) to the operation unit 13. In the book dividing instruction, an electronic book selected by the user and a division portion in the electronic book are designated. As the division portion designated in the book dividing instruction, for example, an arbitrary portion such as a chapter break such as chapter 1, chapter 2, and chapter 3 can be designated.

When the book dividing instruction is input to the operation unit 13, the book dividing unit 17h reads the 3D book data of the electronic book designated in the book dividing instruction from the storage unit 16. Next, the book dividing unit 17h divides the 3D book data read from the storage unit 16 to generate a plurality of pieces of 3D book data so that the electronic book designated in the book dividing instruction is divided into a plurality of electronic books at positions designated in the book dividing instruction. Then, the book dividing unit 17h writes a plurality of pieces of 3D book data generated by the division into the storage unit 16 as new 3D book data.

Therefore, for example, the user can cause the electronic book display system 10 to start displaying one of the plurality of electronic books divided from one electronic book, and read the electronic book as the real-image books. In the real-image book, the number of pages of the electronic book is expressed as a thickness. Therefore, the thickness of the real-image book of each of the plurality of electronic books divided from one electronic book is thinner than the thickness of the real-image book of the electronic book before the division.

Next, an operation of the electronic book display system 10 in a case where a plurality of real-image books is displayed will be described.

The user can input an instruction to align a plurality of real-image books on display (hereinafter referred to as “alignment display instruction”) to the operation unit 13. In the alignment display instruction, a plurality of electronic books selected by the user is designated. The designation of the electronic books in the alignment display instruction may be individually designated for any electronic books, or may be designated by an attribute of the electronic books such as electronic books that the user has read.

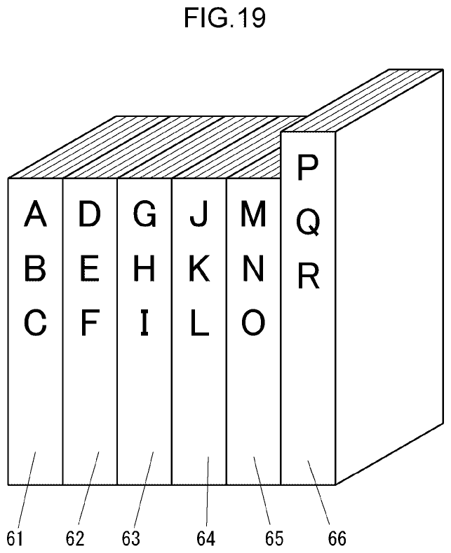

FIG. 19 is a diagram illustrating an example of displayed real-image books 61 to 66 reproduced by a hologram displayed by the SLM 11.

When the alignment display instruction is input to the operation unit 13, the hologram generation unit 17a reads 3D book data of a plurality of electronic books designated in the alignment display instruction from the storage unit 16. Next, the hologram generation unit 17a generates 3D display data including a plurality of pieces of 3D book data read from the storage unit 16 so that a plurality of real-image books corresponding to the plurality of electronic books designated in the alignment display instruction is displayed. Therefore, for example, as illustrated in FIG. 19, the user can view the plurality of displayed real-image books corresponding to the plurality of electronic books designated in the alignment display instruction. For example, the user can identify real-image books that the user himself/herself desires to read from among the plurality of displayed real-image books by checking exteriors such as spine exteriors of the plurality of displayed real-image books.

Next, an operation of the electronic book display system 10 in a case of displaying a bookshelf on which the real-image books are aligned will be described.

The user can input an instruction to display a bookshelf on which the real-image books are aligned (hereinafter, the instruction is referred to as a “bookshelf display instruction”) to the operation unit 13. In the bookshelf display instruction, at least one electronic book selected by the user and a bookshelf selected by the user are designated. The designation of the electronic books in the bookshelf display instruction may be individually designated, or may be designated by an attribute of the electronic books such as the electronic books that the user has read.

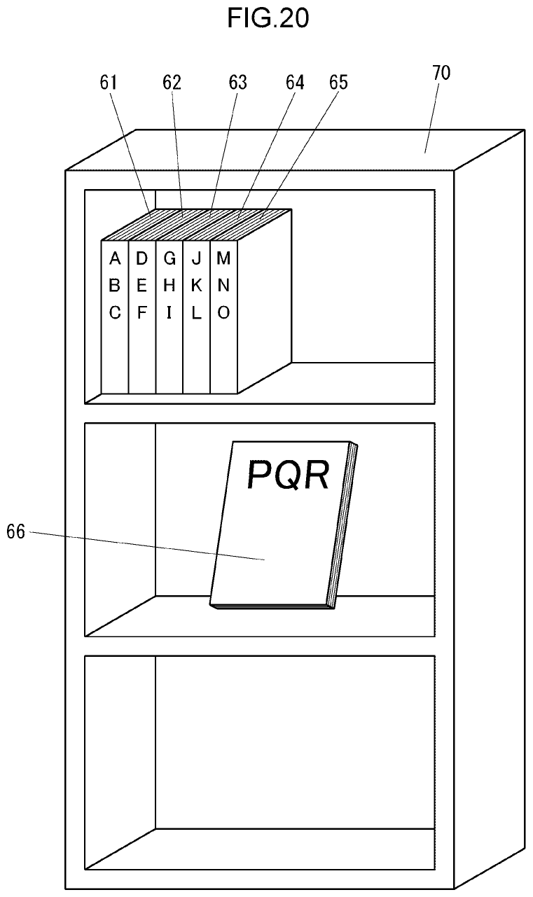

FIG. 20 is a diagram illustrating an example of a bookshelf 70 on which the real-image books 61 to 66 are displayed, the book shelf being reproduced by the hologram displayed by the SLM 11.

When the bookshelf display instruction is input to the operation unit 13, the hologram generation unit 17a reads the 3D book data of the electronic books designated in the book shelf display instruction and the 3D book shelf data of the book shelf designated in the book shelf display instruction from the storage unit 16. Next, the hologram generation unit 17a generates 3D display data including the plurality of pieces of 3D data read from the storage unit 16 so that real-image books corresponding to the electronic books designated in the bookshelf display instruction are displayed on the bookshelf. Therefore, for example, as illustrated in FIG. 20, the user can see the real image of the bookshelf on which the real-image books corresponding to the electronic books designated in the bookshelf display instruction are displayed. For example, the user can identify real-image books that the user himself/herself desires to read from among a plurality of real-image books displayed on the bookshelf by checking exteriors such as the spine exteriors and front exteriors of the real-image books displayed on the bookshelf.

Next, an operation of the electronic book display system 10 in a case where a plurality of real-image books is stacked and displayed will be described.

The user can input an instruction to display a plurality of real-image books which is stacked (hereinafter referred to as “stack display instruction”) to the operation unit 13. In the stack display instruction, a plurality of electronic books selected by the user is designated. The designation of the electronic books in the stack display instruction may be individually designated for any electronic books, or may be designated by an attribute of the electronic books such as electronic books that the user has read.

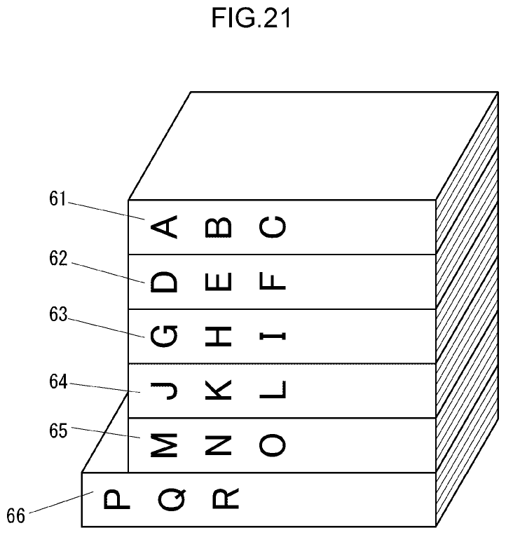

FIG. 21 is a diagram illustrating an example of the stacked real-image books 61 to 66 reproduced by the hologram displayed by the SLM 11.

When the stack display instruction is input to the operation unit 13, the hologram generation unit 17a reads the 3D book data of the plurality of electronic books designated in the stack display instruction from the storage unit 16. Next, the hologram generation unit 17a generates 3D display data including a plurality of pieces of 3D book data read from the storage unit 16 so that the real-image books corresponding to the plurality of electronic books designated in the stack display instruction are stacked. Therefore, for example, as illustrated in FIG. 21, the user can view a stack of the plurality of real-image books corresponding to the plurality of electronic books designated in the stack display instruction. For example, the user can visually obtain a sense of achievement of reading by viewing the stack of the plurality of real-image books read by the user himself/herself. In addition, the user can visually obtain a feeling of achievement of writing to the real-image book by viewing the stack of the plurality of real-image books written by the user. In addition, the user can visually enhance the user's expectation for future reading by viewing the stack of the plurality of real-image books to be read by the user.

Next, utilization of the real-image book as decoration will be described.

For example, the SLM 11 may be arranged on a shelf existing in reality, the SLM 11 may be arranged on a desk existing in reality, or the SLM 11 may be arranged in the vicinity of a position where it is desired by the user that the real-image book is arranged as decoration, so that the real-image book reproduced by the hologram displayed by the SLM 11 can be utilized as a part of decoration inside and outside the room.

As described above, for example, as illustrated in FIG. 6 to FIGS. 15A and 15B, and FIGS. 18A and 18B, the electronic book display system 10 reproduces the electronic book as a stereoscopic image of a book, so that the difference in the appearance of the book from the book of the paper medium can be reduced, and as a result, the comfort of using the electronic book can be improved.

In a case where the position detection unit 14 detects the operation on the real-image book by an object, the electronic book display system 10 generates the hologram in which the real-image book is changed in accordance with the operation detected by the position detection unit 14, for example, as illustrated in FIGS. 8A to 14C. Therefore, it is possible to give the user a feeling of directly operating the real-image book. Therefore, the electronic book display system 10 can reduce a difference in the book operability from the book on the paper medium, and as a result, the comfort of using the electronic book can be improved.

For example, as illustrated in FIGS. 15A and 15B, when the display content of the page of the real-image book is visible from the viewpoint of the user with respect to the SLM 11, the electronic book display system 10 can display, by the SLM 11, the hologram in which at least a part of the exterior of the real-image book that is no visible from the viewpoint of the user is visible from the viewpoint, with respect to the SLM 11, of a person other than the user. Therefore, when the user is viewing the display content of the page of the real-image book, the exterior of the real-image book can be shown to a person other than the user.

The electronic book display system 10 can generate a hologram in which the book cover is not attached to the real-image book as illustrated in FIGS. 15A and 15B, for example, and can generate a hologram in which the book cover is attached to the real-image book as illustrated in FIGS. 18A and 18B, for example, so that the book cover can be attached to the real-image book. Therefore, the user can be excited, for example, by attaching the user's own favorite book cover to the real-image book.

For example, regarding the electronic book display system 10 in a case where the book cover is not attached to the real-image book as illustrated in FIGS. 15A and 15B, when the display content of the page of the real-image book is visible from the viewpoint of the user with respect to the SLM 11, at least a part of the exterior of the real-image book that is not visible from the viewpoint of the user is visible from the viewpoint of a person other than the user with respect to the SLM 11. For example, in a case where the book cover is attached to the real-image book as illustrated in FIGS. 18A and 18B, at least a part of the exterior of the real-image book that is not visible from the viewpoint of the user and visible from the viewpoint of the person other than the user when the book cover is not attached to the real-image book is covered with the book cover. Therefore, when the user is viewing the display content of the page of the real-image book, at least a part of the exterior of the real-image book can be hidden by the book cover from a person other than the user. Therefore, the user can reduce the possibility that the person other than the user immediately recognizes what book the user is reading, for example, by attaching the book cover to the real-image book.

The electronic book display system 10 makes the appearance of the real-image book reproduced by the hologram according to the reading amount of the electronic book, for example, as illustrated in FIGS. 7A and 7B, and thus, it is possible to allow the user to easily recognize the reading amount of the electronic book.

In a case where the operation of breaking the page of the real-image book is executed as illustrated in FIGS. 13A to 13C, the electronic book display system 10 generates the hologram in which the page of the real-image book is broken as illustrated in FIG. 13C, and thus, the difference from a book of a paper medium in terms of operability and appearance of the book can be reduced, and as a result, the comfort of using the electronic book can be improved.

In a case where the operation of folding the page of the real-image book is executed as illustrated in FIGS. 14A to 14C, the electronic book display system 10 generates the hologram in which the page of the real-image book is folded as illustrated in FIG. 14C, and thus, the difference from a book of a paper medium in terms of operability and appearance of the book can be reduced, and as a result, the comfort of using the electronic book can be improved.

Since the electronic book display system 10 generates the hologram so that the page of the real-image book is turned at a speed corresponding to the property amount of the component of the real-image book, the speed at which the page of the real-image book is turned can be set to a speed corresponding to the property amount of the component of the real-image book.

In a case where the appearance of the real-image book is changed, the electronic book display system 10 sets the property amount corresponding to the changed appearance to the electronic book, so that the speed at which the page of the real-image book is turned can be set to a speed corresponding to the appearance of the real-image book.

Since the electronic book display system 10 reproduces the image of the book by the hologram displayed by the SLM 11, there is a high possibility that it is not necessary to focus on the screen of the SLM 11, and as a result, the burden on the user's eyes can be reduced as compared with a conventional electronic book that needs to focus on the screen.

In the electronic book display system 10, at least a part of various instructions received by the operation unit 13 according to the present embodiment may be received by the communication unit 15 from, for example, an electronic device such as a personal computer (PC) or a smartphone of the user. The electronic book display system 10 may reproduce the operation unit as a real image by the hologram displayed by the SLM 11, and at least a part of the various instructions received by the operation unit 13 according to the present embodiment may be received by the position detection unit 14 as an operation on the operation unit reproduced as a real image by the hologram displayed by the SLM 11.

According to the present embodiment, the electronic book display system 10 includes the stand 18 that supports the SLM 11. However, the electronic book display system 10 may not include the stand 18.

According to the present embodiment, the electronic book display system 10 reproduces the electronic book as a real image of a book by the hologram displayed by the SLM 11. However, when the operation on the image of the book reproduced by the hologram displayed by the SLM 11 is not detected by the position detection unit 14, the electronic book display system 10 may reproduce the electronic book as a virtual image of the book by the hologram displayed by the SLM 11. When an electronic book is reproduced as a virtual image of a book by a hologram displayed by the SLM 11, an operation on the image of the book may be input by the operation unit 13, for example.

What is claimed is:

1. An electronic book display system comprising:
a hologram generation unit that generates a hologram to reproduce an electronic book as a stereoscopic image of a book; and
a display control unit that causes a spatial light modulator (SLM) to display the hologram generated by the hologram generation unit.

2. The electronic book display system according to claim 1, wherein the hologram is to reproduce a real image of the book.

3. The electronic book display system according to claim 2, wherein
regarding the electronic book, a property amount, as an amount of property of a component of the book, is set, and
the hologram generation unit generates the hologram such that a page of the book is turned at a speed corresponding to the property amount.

4. The electronic book display system according to claim 3, further comprising
a property amount change unit that changes the property amount set to the electronic book according to an instruction.

5. The electronic book display system according to claim 3, wherein, in a case where an appearance of the book is changed according to an instruction so as to change a type of the component, the hologram generation unit sets the property amount corresponding to the changed appearance to the electronic book.

6. The electronic book display system according to claim 1, wherein the hologram generation unit can generate the hologram in which, while a display content of a page of the book is visible from a first viewpoint with respect to the SLM, at least a part of an area of an exterior of the book that is not visible from the first viewpoint is visible from a second viewpoint with respect to the SLM.

7. The electronic book display system according to claim 6, wherein
the hologram generation unit can generate a first hologram that is the hologram in which, while the display content of the page of the book is visible from the first viewpoint, at least a part of the area of the exterior of the book that is not visible from the first viewpoint is visible from the second viewpoint, and can generate a second hologram that is the hologram that is different from the first hologram in that a book cover covering at least a part of the exterior of the book is attached to the book, and
in the second hologram, the book cover covers at least a part of the area of the exterior of the book that is not visible from the first viewpoint and is visible from the second viewpoint in the first hologram.

8. The electronic book display system according to claim 2, further comprising
a position detection unit that detects a spatial position of an object in a region for a real image of the book to detect an operation by the object with respect to the real image of the book that is reproduced by the hologram,
wherein, in a case where the position detection unit detects an operation by the object with respect to the real image of the book, the hologram generation unit generates the hologram in which the real image of the book is changed according to the operation detected by the position detection unit.

9. The electronic book display system according to claim 1, wherein the hologram generation unit generates an appearance of the book to be an appearance corresponding to how much the electronic book has been read.

10. The electronic book display system according to claim 1, wherein, in a case where an operation of breaking a page of the book is executed, the hologram generation unit generates the hologram in which the page is broken.

11. The electronic book display system according to claim 1, wherein, in a case where an operation of folding a page of the book is executed, the hologram generation unit generates the hologram in which the page is folded.

12. A computer-readable non-transitory storage medium storing an electronic book display program that causes a computer to realize:
a hologram generation unit that generates a hologram to reproduce an electronic book as a stereoscopic image of a book; and
a display control unit that causes a spatial light modulator (SLM) to display the hologram generated by the hologram generation unit.

13. The storage medium according to claim 12, wherein the hologram is to reproduce a real image of the book.

14. The storage medium according to claim 13, wherein
regarding the electronic book, a property amount, as an amount of property of a component of the book, is set, and
the hologram generation unit generates the hologram such that a page of the book is turned at a speed corresponding to the property amount.

15. The storage medium according to claim 14, wherein the electronic book display program causes a computer to realize a property amount change unit that changes the property amount set to the electronic book according to an instruction.

16. The storage medium according to claim 14, wherein, in a case where an appearance of the book is changed according to an instruction so as to change a type of the component, the hologram generation unit sets the property amount corresponding to the changed appearance to the electronic book.

17. The storage medium according to claim 12, wherein the hologram generation unit can generate the hologram in which, while a display content of a page of the book is visible from a first viewpoint with respect to the SLM, at least a part of an area of an exterior of the book that is not visible from the first viewpoint is visible from a second viewpoint with respect to the SLM.
